(19) United States
(12) Patent Application Publication
(10) Pub. No.: US 2008/0310907 A1
(43) Pub. Date: Dec. 18, 2008

(54) Printer

(76) Inventor: Takuro Kohyama, Tokyo (JP)

Correspondence Address: SMITH, GAMBRELL & RUSSELL, 1130 CONNECTICUT AVENUE, N.W., SUITE 1130, WASHINGTON, DC, 20036, US

(21) Appl. No.: 11/658,349

(22) PCT Filed: Oct. 4, 2005
(86) PCT No.: PCT/JP2005/018366

§ 371 Date: Jan. 24, 2007

(30) Foreign Application Priority Data
Oct. 6, 2004 (JP) 2004-294213

(51) Int. Cl. B41J 13/00

(52) U.S. Cl. 400/642

(57) ABSTRACT

In a printer (1) using a cassette-type ink ribbon, a paper exit (8) serves also as an ink ribbon inlet. A paper cutter (11) is located in a position where it restricts an exit course for a paper sheet. A part of the upper surface of a head cover (9) is once raised, and a slope (10) is then extended toward a print gap. The slope (10) serves as a ribbon guide surface.

### TECHNICAL FIELD

The present invention relates to a printer of a type that utilizes a cassette-type ink ribbon and is provided with a paper cutter.

### BACKGROUND ART

Various proposals have been made to facilitate replacement of an ink ribbon cassette in a printer that utilizes a cassette-type ink ribbon.

In a first prior art example (see Japanese Patent Application Laid-Open No. 8-187923), an ink ribbon cassette 32 shown in FIG. 4 is inserted into a head cover that covers a print mechanism including a print head, and the head cover is configured to get into a space 32b defined between a case 32a of the ink ribbon cassette and an ink ribbon 33 that is exposed from the case 32a. When the ink ribbon cassette 32 is inserted, the distance between driving rollers and driven rollers for paper feed widens.

In a second prior art example (see Japanese Patent Application Laid-Open No. 6-55806), as shown in FIG. 5, an ink ribbon cassette 42 is inserted into a head cover 29 that covers a print unit, and the head cover 29 is configured to get into a space 42b defined between a case 42a of the ink ribbon cassette 42 and an ink ribbon that is exposed from the case 42a. A front slope 29a of the head cover 29 has a structure such that the ink ribbon that is exposed from the case 42a can be guided toward a position where it faces a print head as the ink ribbon cassette 42 is inserted.

In many of printers that utilize cassette-type ink ribbons, an ink ribbon that is exposed from a case of an ink ribbon cassette passes through a slit-shaped paper exit through which a printed paper sheet is discharged and reaches a position where it faces a head. Thus, in many cases, the paper exit is used directly as an ink ribbon inlet.

Although not disclosed in the two patent documents described above, the printed paper sheet that is discharged through the paper exit is cut by a paper cutter. In consideration of adhesion to the paper sheet to be cut, the paper cutter is provided in an exit course for the printed paper sheet.

In a printer of a type such that an ink ribbon of an ink ribbon cassette is inserted through the paper exit and the paper cutter is provided on the downstream side of the paper exit, therefore, the paper exit sometimes may be hidden by the paper cutter and cannot be easily recognized as the ink ribbon inlet. It is difficult, moreover, to insert the ink ribbon, which is exposed for a fixed length from the cassette case and expected to be loaded, into the narrow slit-shaped paper exit without interfering with the paper cutter. Thus, the ink ribbon may frequently be caught by an edge of the paper cutter or soil hands.

### DISCLOSURE OF THE INVENTION

A printer according to the present invention is of a type such that a paper exit through which a printed paper sheet is discharged serves also as an ink ribbon inlet through which an ink ribbon is inserted into a print gap defined between a print head and the paper sheet, and besides, a paper cutter for cutting the printed paper sheet discharged through the paper exit to a suitable length is set in a position such as to restrict an exit course for the printed paper sheet.

A slope inclined at an angle to the print gap is provided in the paper exit so as to face the paper cutter, the slope having a length such that the ink ribbon is guided in contact with the slope when the ink ribbon is inserted into the ink ribbon inlet.

The slope may be formed integrally on a head cover which covers the print head.

The head cover may have a protuberance formed on a part of the upper surface thereof, the slope extending from a region near the top of the protuberance toward the paper exit.

In the printer of a type such that the paper exit through which the printed paper sheet is discharged serves also as the ink ribbon inlet, according to the present invention, as described above, the paper cutter is located in the position where it blocks up the paper exit course in consideration of enhancement of the adhesion between the paper sheet to be cut and the paper cutter. Even if this is done, the ink ribbon can be smoothly fed in toward the paper exit, which serves also as the ink ribbon inlet, without being hindered by the paper cutter as the ink ribbon is slid on a long inclined ribbon guide surface.

### BRIEF DESCRIPTION OF THE DRAWINGS

FIG. 1 is a side view of one embodiment of a printer according to the present invention;

FIG. 2 is an enlarged view showing principal parts of a printing section of the printer of FIG. 1;

FIG. 3 is a rear view of the printing section of the printer of FIG. 1;

FIG. 4 is a perspective view of an ink ribbon cassette used in a printer according to a first prior art example; and

FIG. 5 is a perspective view of a printer according to a second prior art example.

### BEST MODE FOR CARRYING OUT THE INVENTION

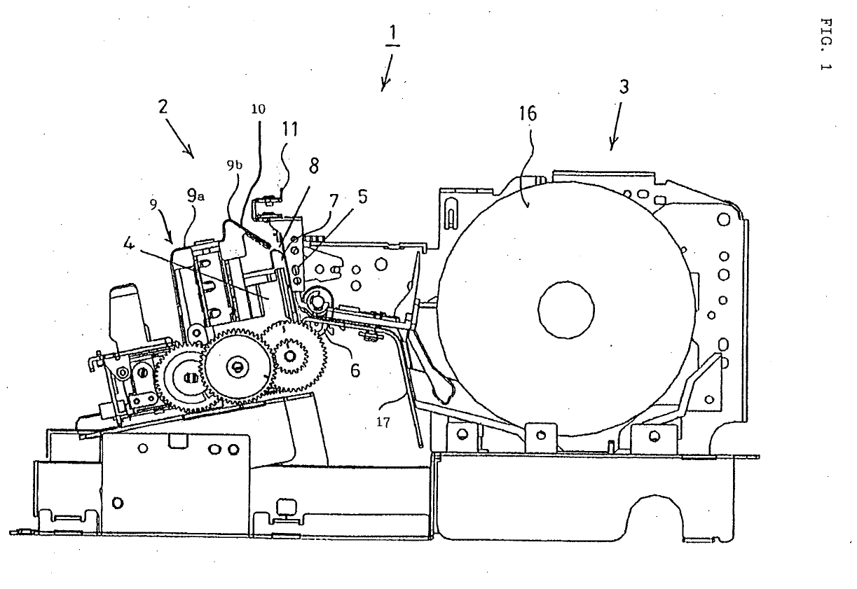

FIG. 1 shows a printer 1 with its printer cover off. However, a head cover 9 that forms a part of a print head 4 is shown in the drawing.

The printer 1 comprises a printing section 2 and a paper roll holder 3. The printing section 2 has a print head 4, a platen 5, and a pair of feed-in rollers 6. An exit course for a paper sheet in the printing section 2 is defined between the print head 4 and the platen 5. In front of the print head 4, a ribbon guide portion 7 is formed extending along the paper exit course. A print gap is defined between the front face of the ribbon guide portion 7 and the paper sheet. A slit-shaped paper exit 8 is formed in an open space over the ribbon guide portion 7. The printed paper sheet is discharged through the paper exit 8 and moves upward.

The printed paper sheet discharged through the paper exit 8 and moved upward is cut to a predetermined length by a paper cutter 11. The paper cutter 11 is located in a position where it restricts the exit course for the paper sheet that is discharged through the paper exit 8 (i.e., located in a position that hinders linear movement of the paper sheet discharged through the paper exit 8). The paper cutter 11 comprises a manual cutter 11a and an auto-cutter 11b, and the auto-cutter 11b has a movable blade (not shown).

Since the paper cutter 11 is provided in the position where it restricts the paper exit course, the paper sheet can be easily pressed against the paper cutter 11 for cutting the paper sheet. Thus, the adhesion between the printed paper sheet discharged through the paper exit 8 and the paper cutter 11 can be enhanced, so that paper cutting operation is easy and secure.

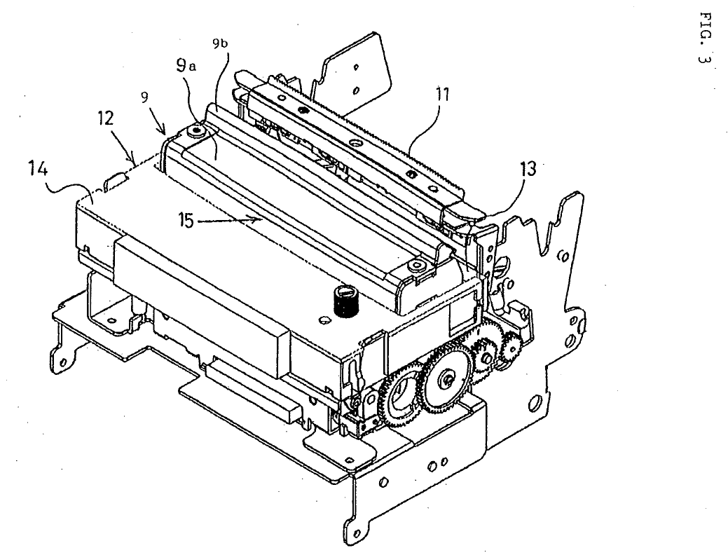

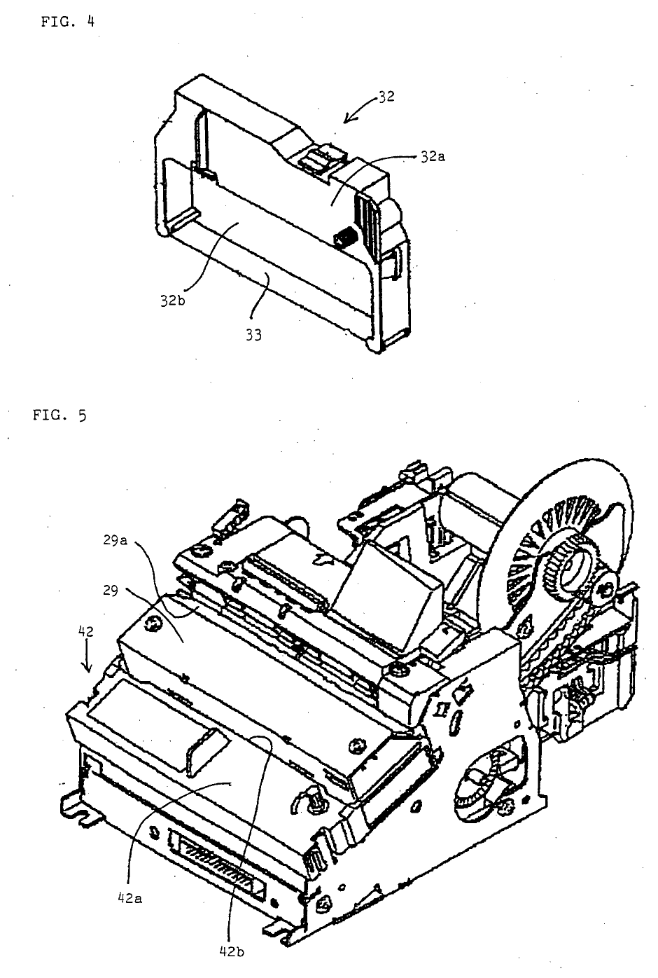

On the other hand, an ink ribbon 13 that is exposed from a case 14 of an ink ribbon cassette 12 (FIG. 3) is placed on the front face (surface that faces the platen 5) of the print head 4. In mounting the ink ribbon 13 on the front face of the print head 4, the ink ribbon 13 that is exposed from the case 14 of the ink ribbon cassette 12 is first inserted into the paper exit 8 from above. Thereupon, the ink ribbon 13 that is passed through the paper exit 8 moves to the ribbon guide portion 7 and is guided by the ribbon guide portion 7 as it is delivered to the front face of the print head 4.

As described above, however, the paper cutter 11 projects to the position where it restricts the exit course for the paper sheet. In feeding the ink ribbon 13 into the paper exit 8, therefore, the ink ribbon must be passed along a path that bypasses the paper cutter 11, that is, a path that is situated off the paper exit course.

According to the present invention, therefore, an inclined ribbon guide surface 10 is provided extending long in a straight line toward the paper exit 8 that serves also as an ink ribbon inlet. Thus, the ink ribbon 13 is guided in contact with the ribbon guide surface 10 to be led to the paper exit.

The ribbon guide surface 10 is a long slope that declines rearward with respect to the course for the paper sheet that is discharged through the paper exit 8. Although the paper cutter 11 projects rearward to the position where it restricts the exit course for the paper sheet, therefore, a wide space can be secured between the ribbon guide surface 10 and the paper cutter 11. Thus, the ink ribbon 13 can be smoothly placed on the ribbon guide surface 10 and slid on the ribbon guide surface 10 to the paper exit 8 without being hindered by the presence of the paper cutter 11. The following is a description of the way of forming the ribbon guide surface 10.

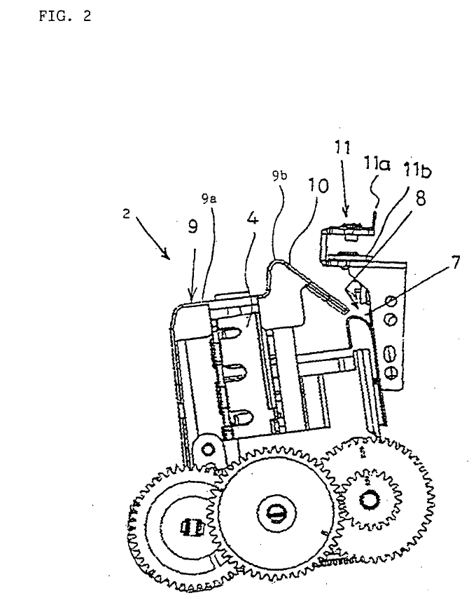

The top of the print head 4 is covered by the head cover 9. The head cover 9 is a molded plastic product, of which the upper surface forms a flat surface 9a at a part distant from the paper exit 8, as shown in FIG. 2. At a part nearer to the paper exit 8, the upper surface partially rises to form a protuberance 9b. As shown in FIG. 3, the protuberance 9b is formed covering the overall width of the head cover 9 (that is equal to the width of the ribbon guide surface 10). The inclined ribbon guide surface 10 is formed extending long in a straight line from the top of the protuberance 9b toward the paper exit 8 that is located in front of and below it.

Since the ribbon guide surface 10 thus starts at the protuberance 9b of the head cover 9, the length of the inclined ribbon guide surface 10 can be increased, so that the space between the ribbon guide surface 10 and the paper cutter 11 can be widened. When the ink ribbon 13 is placed on the ribbon guide surface 10 or when the ink ribbon 13 is guided and slid down on the ribbon guide surface 10, therefore, there is no possibility of the ink ribbon 13 being hindered by the paper cutter 11 that projects rearward to the position where it restricts the paper exit course.

In guiding the ink ribbon 13 onto the ribbon guide surface 10, the protuberance 9b of the head cover 9 is first caused to get into a space between the case 14 of the ink ribbon cassette 12 and the ink ribbon 13 that is exposed from the case 14.

As the ink ribbon cassette 12 is fitted to the protuberance 9b of the head cover 9, the ink ribbon 13 that is exposed from the case 14 is guided on the ribbon guide surface 10 as it descends, and transfers from the ribbon guide surface 10 to the paper exit 8. Then, the ink ribbon 13 passes through the paper exit 8 and is further guided by the ribbon guide portion 7 to be finally located on the front face of the print head 4.

The paper roll holder 3 (FIG. 1) is in the form of a container, which is loaded with a paper roll 16. The paper sheet that is paid out from the paper roll 16 as the feed-in rollers 6 rotate travels along a guide plate 17 and gets out of the paper roll holder 3. Then, the paper sheet is fed into a printing position between the print head 4 and the platen 5, whereupon printing is performed. The printed paper sheet is cut automatically or manually to a desired length by means of the paper cutter 11.

1. A printer, which comprises a paper cutter located so as to restrict an exit course for a paper sheet discharged through a paper exit, and in which the paper exit serves also as an ink ribbon inlet through which an ink ribbon is inserted into a print gap defined between a print head and the paper sheet, wherein
a slope inclined at an angle to the print gap is provided in the paper exit so as to face the paper cutter; and
the slope has a length such that the ink ribbon is guided in contact with the slope when the ink ribbon is inserted into the ink ribbon inlet.

2. The printer according to claim 1, wherein the slope is formed integrally on a head cover which covers the print head.

3. The printer according to claim 2, wherein the head cover has a protuberance formed on a part of the upper surface thereof, and the slope extends from a region near the top of the protuberance toward the paper exit.

4. The printer according to claim 3, wherein the protuberance is formed covering the overall width of the head cover.
